(19) United States
(12) Patent Application Publication
(10) Pub. No.: US 2012/0262003 A1
(43) Pub. Date: Oct. 18, 2012

(54) RECEIVER POWERED BY A WIRELESS INTERFACE OF INDUCTIVE TYPE

(75) Inventor: Yann Tetu, Grenoble (FR)

(73) Assignee: Commissariat a I'energie atomique et aux energies alternatives, Paris (FR)

(21) Appl. No.: 13/448,726

(22) Filed: Apr. 17, 2012

(30) Foreign Application Priority Data
Apr. 18, 2011 (FR) 1153354

(51) Int. Cl. H01F 38/14

(52) U.S. Cl. 307/104

(57) ABSTRACT

The invention relates to a receiver (3) furnished with a resonant antenna with inductive coupling, comprising:
an inductive antenna circuit (A3);
a circuit powered by the inductive antenna circuit and which can be modelled by a capacitor (C3) and a resistor (R3) which are connected in parallel with the antenna circuit.

The inductive antenna circuit comprises at least two conducting loops (L1, L2) connected electrically in parallel, disposed in parallel surfaces and exhibiting substantially zero mutual inductance.

### RELATED APPLICATIONS

Under 35 USC 119, this application claims the benefit of the priority date of French Patent Application 1153354, filed Apr. 18, 2011, the contents of which are herein incorporated by reference.

### FIELD OF DISCLOSURE

The invention relates to wireless energy transmission (typically energy transmission by a contactless interface), and in particular to the powering of a receiver of inductive RFID type.

### BACKGROUND

A growing number of applications are calling upon wireless transmissions. Communication systems of inductive RFID type have in particular been developed and are experiencing a significant upsurge. Such a system comprises a base station or reader, and an autonomous object comprising an identification number and operating as a remotely powered receiver. The receiver is generally called a tag when it is affixed to a product, or called a contactless card when it is intended for the identification of persons.

Moreover, remote power supply systems of inductive RFID type are also developed, for example for recharging batteries of a subcutaneous implant or of an electronic apparatus.

In such systems, a link is established by radiofrequency magnetic field between the reader and one or more receivers. This magnetic field is quasi-stationary. The reader and receiver coupling units are conducting circuits including loops, windings or coils forming an antenna circuit. Electronic components are associated with the antenna circuit whose function is to carry out frequency tuning, damping or impedance matching. The association of the antenna circuit and of the electronic components is usually designated by the term antenna. The antenna of the reader can be regarded as a series or parallel RLC resonating circuit connected to a generator. The antenna of the receiver can be regarded as an RLC parallel resonating circuit.

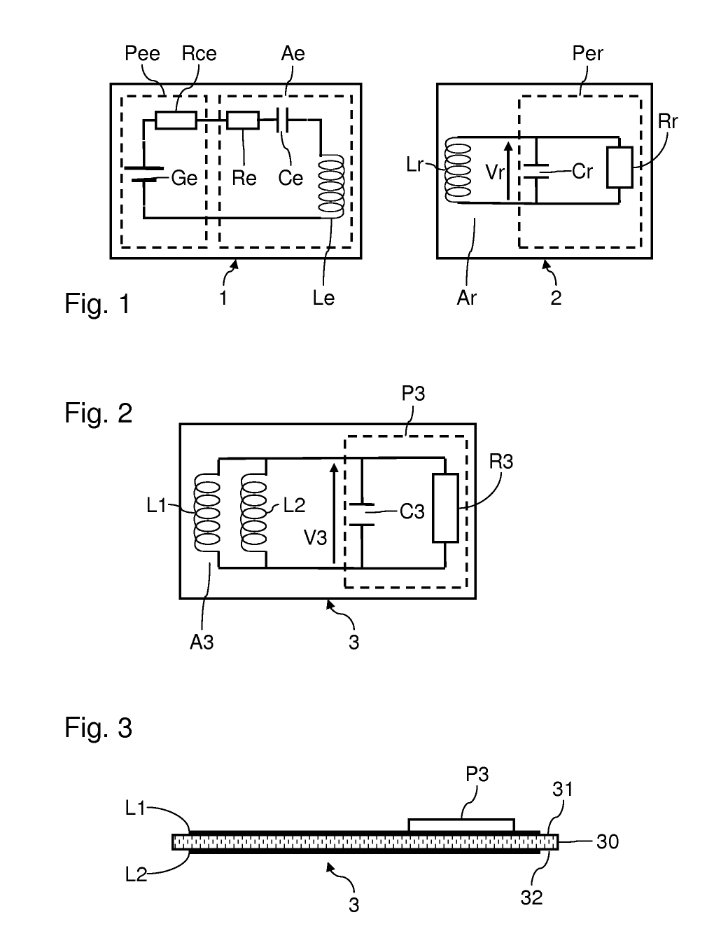

FIG. 1 provides a schematic example of the conventional electrical representation of a reader 1 (whose antenna is regarded as a series RLC circuit) 5 and of an RFID receiver 2 of inductive type.

Reader side, the antenna circuit Ae is represented by an equivalent inductance Le, in series with a resistor Re and a capacitor Ce. The antenna circuit Ae is connected to an electronic circuit Pee of the reader. The output impedance of the reader is modelled by a resistor Rce, connected in series with the antenna circuit Ae and a power supply Ge. A parallel RLC modelling reader side is also possible.

Receiver side, the antenna circuit Ar is represented by an equivalent inductance Lr. The antenna circuit Ar is connected to an electronic circuit Per. The electronic circuit contains a capacitor Cr. A resistor Rr models the electrical consumption of this electronic circuit and is connected in parallel to the equivalent inductance Lr. This parallel modelling corresponds to the vast majority of receivers. This architecture is predominantly retained for reasons of current and voltage employed and/or reasons of simplicity.

The inductive coupling induces the transfer of energy between the reader and the receiver by mutual inductance. When the receiver is placed sufficiently close to the reader, the antenna of the reader is coupled to the antenna of the receiver. An alternating voltage or electromotive force is thus induced in the receiver. This voltage is rectified and generally used to power the functions of the receiver.

To allow the transmission of data from the receiver to the reader, the receiver modifies the impedance that it exhibits at the terminals of the antenna circuit. This impedance variation is detected by the reader on account of the inductive coupling. Recommendations for the design of RFID systems of inductive type are in particular defined in standards ISO 15693, ISO 18000-3 and ISO 14443. These standards fix in particular the transmission frequency at a frequency of 13.56 MHz. The ISO 18000-2 standard fixes the transmission frequency at a level of less than 135 KHz. In practice, the communication distance between the reader and the receiver is relatively small, typically lying between about ten cm and a metre for these frequencies.

A usual antenna circuit comprises a conducting track with one or more loops, fixed to a support. This track is generally formed as close as possible to the periphery of the support, so as to optimize or maximize the electromagnetic flux which crosses it. The number of loops of the track is generally fixed so as to address the following two constraints: allow the recovery of a sufficient quantity of energy and make it possible to obtain a sufficient passband for data communication. In practice, the higher the number of loops, the greater the passband for data communication. The smaller the number of loops, the greater the power transmission. Consequently, the design of the antenna circuit requires a compromise, the receiver not then being optimized for its energy recovery.

Document US2010/0283698 describes in particular an antenna circuit comprising two conducting loops connected electrically in parallel and disposed in parallel surfaces. These conducting loops exhibiting superposed identical geometries, their mutual inductance is maximized.

Document EP0541323 describes a transponder in the form of a contactless card. One of the antenna circuits described comprises two conducting loops connected electrically in parallel while wound in a concentric manner. The conducting loops are distributed in two parallel surfaces, with a view to harmonizing the lengths of the two loops.

RFID systems of inductive type are sensitive to the problem of the load effect between the reader and the receiver. Indeed, the resonator formed by the reader is coupled with that of the receiver. This coupling leads to a greater or lesser mismatch transmit side. In practice the presence of the receiver generates an impedance on the resonant circuit of the reader. This impedance is a mutual inductance

M=k\sqrt{L_{e*L}ᵣ}

where k is the coupling coefficient for the 2 antennas and Le, Lr the inductances of the respective antenna circuits of the reader and of the receiver. This mutual inductance introduces a shift in the resonant frequency of the reader. This effect is all the greater the greater the quality factors of the resonators used.

### SUMMARY

In practice, a so-called critical coupling position corresponds to the distance at which the transfer of energy between the reader and the receiver is optimized, on account of impedance matching between the output impedance of the reader and the receiver impedance returned to the antenna of the reader by coupling.

However, the critical coupling distance remains extremely small with respect to the requirements of a large number of applications. In other applications, such as the powering of subcutaneous implants, it would be desirable to be able to achieve remote powering by means of a field of small amplitude.

The invention is aimed at solving one or more of these drawbacks. The invention thus pertains to a receiver furnished with a resonant antenna with inductive coupling, comprising:

an inductive antenna circuit;

a circuit powered by the inductive antenna circuit and which can be modelled by a capacitor and a resistor which are connected in parallel with the antenna circuit.

The inductive antenna circuit comprises at least two conducting loops connected electrically in parallel, disposed in parallel surfaces and exhibiting substantially zero mutual inductance.

According to a variant, the two conducting loops exhibit substantially equal values of inductance.

According to a further variant, the two conducting loops are disposed on parallel surfaces of one and the same support on which they are fixed.

According to another variant, the support is a substrate on which an electronic circuit powered by the inductive antenna circuit is fixed.

According to yet another variant, the electronic circuit comprises an electrical load to be powered and a rectifier circuit connected to the terminals of the inductive antenna circuit and applying a rectified voltage to the terminals of the said electrical load.

According to a variant, the said parallel surfaces are plane.

According to a further variant, the resonant frequency of the assembly including the inductive antenna circuit, the capacitor and the resistor is substantially equal to 13.56 MHz.

According to another variant, the two conducting loops exhibit one and the same direction of maximum sensitivity to a magnetic field.

According to yet another variant, the distance between the said parallel surfaces is less than 1 millimetre.

According to a variant, the said two conducting loops are first loops disposed in first parallel surfaces, the inductive antenna circuit comprising at least two second conducting loops connected electrically in parallel, exhibiting substantially zero mutual inductance and disposed in second parallel surfaces, the second parallel surfaces being non-parallel to the first surfaces.

According to a further variant, the inductive antenna circuit exhibits a quality factor of greater than 30.

According to another variant, the cross-section of each of the said two loops is less than 0.16 m²

According to yet another variant, the said two loops are superposed and extend according to interleaved patterns.

According to a variant, the said loops are formed of respective conducting circuits of similar shapes, the said conducting circuits being shifted with respect to one another in the said parallel surfaces.

According to a further variant, the said two conducting loops are connected in parallel by way of first and second terminals, so that the two conducting loops induce one and the same electromotive force between the first and second terminals.

Other characteristics and advantages of the invention will emerge clearly from the description thereof given hereinafter, by way of wholly nonlimiting indication, with reference to the appended drawings, in which:

### DETAILED DESCRIPTION

FIG. 1 is an equivalent electrical representation of a system including a reader and an RFID receiver of inductive type;

FIG. 2 is an equivalent electrical representation of an exemplary receiver of inductive type according to the invention;

FIG. 3 is a sectional view of a receiver according to a first embodiment of the invention;

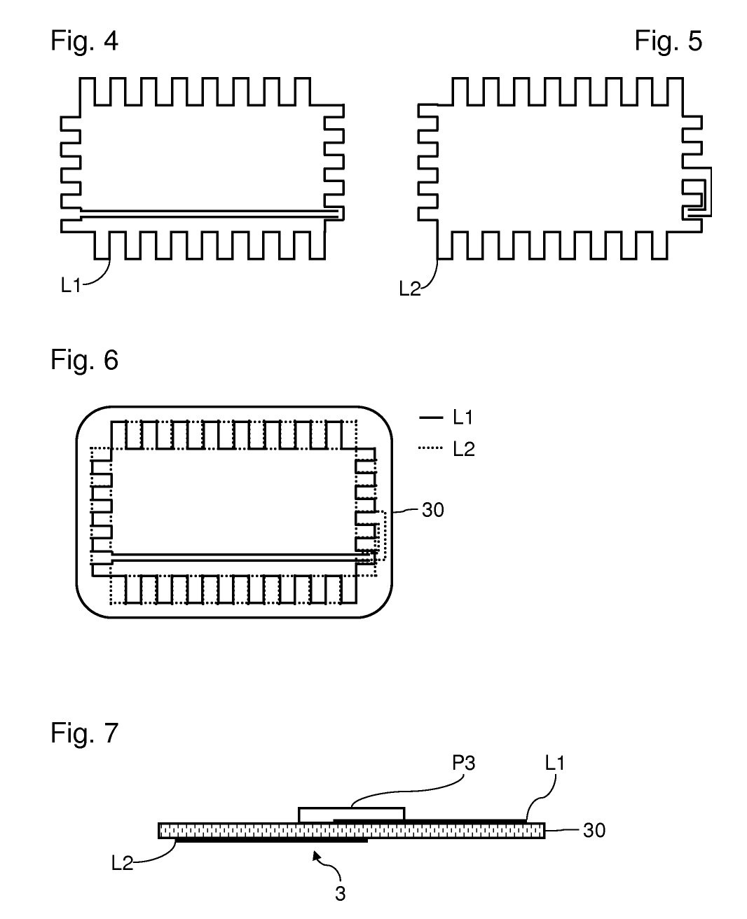

FIGS. 4 and 5 are views from above of loops of the antenna circuit of the receiver of FIG. 3;

FIG. 6 is a view from above of the receiver of FIG. 3;

FIG. 7 is a sectional view of a receiver according to a second embodiment of the invention;

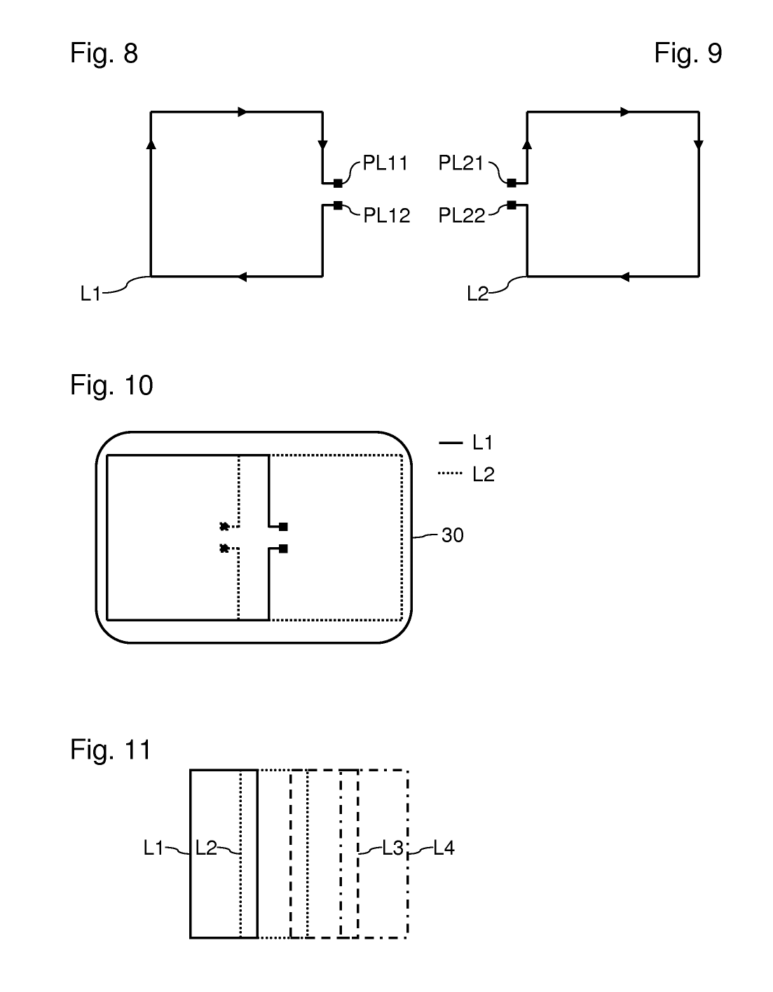

FIGS. 8 and 9 are views from above of loops of the antenna circuit of the receiver of FIG. 7;

FIG. 10 is a view from above of the receiver of FIG. 7;

FIG. 11 is a schematic representation viewed from above of a superposition of loops of the antenna circuit according to another embodiment of the invention;

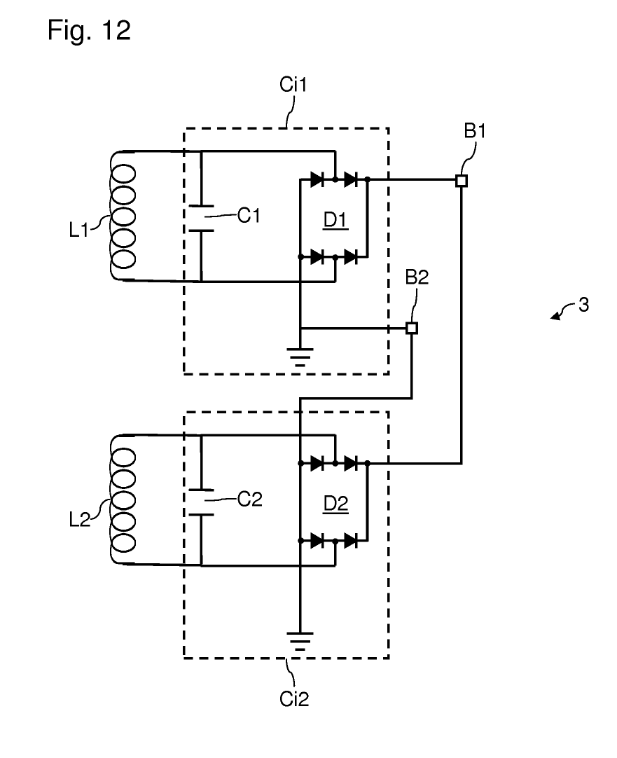

FIG. 12 is a schematic electrical representation of an exemplary receiver structure according to the invention.

The invention proposes a receiver powered by its wireless interface of inductive type. The invention proposes a configuration of the inductive antenna circuit of the receiver making it possible to increase the distance of remote power supply or making it possible to limit the amplitude of the field emitted for a given remote power supply distance. The section which follows will present a theoretical approach established by the inventors for determining optimal dimensioning parameters for the antenna circuit of a receiver.

Referring to the example of FIG. 1, the inductance Lr is embodied in the form of concentric conducting loops connected in series, surrounding a support of the receiver. With w the angular frequency of the carrier of the signal transmitted by the reader, we have:

$$Vr = \frac{Rr}{Rr * ( 1 - Lr * Cr * {ω}^{2} ) + j * Lr * ω} e$$

The electromotive force e may be expressed as follows:

e=−j*ω₀*S*μ₀*H

With S the cross-section surrounded by the set of conducting loops of the inductance Lr and H the amplitude of the magnetic field generated by the signal of the reader at the level of the antenna circuit.

Starting from the assumption that the quality factor of the antenna circuit is much greater than the quality factor of the circuit Per, the quality factor Q of the receiver is:

$$Q = \frac{Rr}{Lr * {ω}_{0}}$$

At the resonant frequency, ω=ω0 and Lr*Cr*ω0²=1

We then have: Ve=−j*Qe=−Q*S*ω0*μ0*H

The power available at the level of the antenna circuit may be written:

$${P}_{R} = \frac{{Vr}^{2}}{Rr} = \frac{{Vr}^{2}}{Q * Lr * {ω}_{0}}$$

Hence:

$${P}_{r} = Vr * \frac{{μ}_{0} * S}{Lr} H$$

The 2nd term of the equation in fact represents the current in the antenna IR:

$${I}_{r} = \frac{{μ}_{0} * S}{Lr} H$$

The ratio S/Lr is therefore predominant for obtaining maximum recovered power Pr, at constant magnetic field H. If n is the number of loops, S is proportional to n and Lr to n². The available power Pr is therefore inversely proportional to the number of loops. It is with a single loop that the maximum power Pr can be recovered.

The invention proposes an antenna circuit structure optimizing this ratio S/Lr.

FIG. 2 is an equivalent schematic electrical representation of an exemplary receiver 3 furnished with a resonant antenna with inductive coupling. As in the example of FIG. 1, the receiver 3 comprises an inductive antenna circuit A3, and a circuit modelled by a capacitor C3 and a resistive circuit R3 which are connected in parallel with the inductive antenna circuit A3. The inductive antenna circuit A3, the capacitor C3, and the resistive circuit R3 form a resonant circuit whose resonant frequency is close to the carrier of the signal transmitted by the reader. This resonant frequency may for example be equal to 13.56 MHz to comply with the standards ISO 15693, ISO 18000-3 or ISO 14443.

The inductive antenna circuit A3 comprises conducting loops L1 and L2. These conducting loops are electrically parallel connected. The conducting loops L1 and L2 are disposed in parallel surfaces and exhibit substantially zero mutual inductance. It will be considered that conducting loops exhibiting a coupling coefficient of less than 5% have substantially zero mutual inductance. This coupling coefficient will advantageously be less than 1%.

Parallel surfaces designate mathematically surfaces that are equally distant from one another at any point. The surfaces carrying the antenna loops can thus be three-dimensional surfaces, such as cylindrical portions or spherical portions for example. For the sake of simplification, the embodiments presented subsequently comprise plane surfaces in which the conducting loops are disposed. On account of the disposition of the conducting loops L1 and L2 in parallel planes, these loops exhibit one and the same direction of maximum sensitivity to a magnetic field.

For loops L1 and L2 having one and the same inductance value L, the inductance equivalent to the antenna circuit A3 equals L/2 in the case of a zero mutual inductance between these loops L1 and L2. Moreover, the antenna circuit A3 comprises two surfaces surrounded by the loops L1 and L2 and sensitive to the magnetic field of the reader.

The solution of the invention thus makes it possible to obtain a ratio S/L increasing the distance at which remote powering may be obtained or reducing the field necessary to achieve remote powering for a given distance, doing so even with a small antenna size. Optimal energy recovery at an increased distance can thus be obtained.

The invention advantageously applies to circuits in which the quality factor of the antenna circuit is greater than 30, or in which the quality factor of the antenna circuit is at least 5 times greater than the quality factor of the circuit Per connected to the antenna, preferably at least 10 times greater. An antenna circuit exhibiting a high quality factor will be able to induce an increase in the distance interval for which remote powering of the receiver may be achieved. The antenna circuit may be considered to be the inductive circuit part connected in parallel to the load to be powered and to the capacitor of the resonant circuit.

To favour a small value of inductance of the inductive antenna circuit A3, the conducting loops L1 and L2 advantageously exhibit equal values of inductance, and advantageously identical cross-sections. The difference between the inductance values of the conducting loops L1 and L2 is for example limited to 10%, or indeed limited to 5%.

In the example, the conducting loops L1 and L2 are disposed on parallel faces of one and the same support on which the loops L1 and L2 are fixed. The support may be a substrate on which is fixed an electronic circuit P3, or an electronic chip or electronics as discrete components, exhibiting a resistance modelled by R3 and a capacitance modelled by C3. The electronic circuit P3 can include an electrical load to be powered (for example an assembly of electronic components) as well as a rectifier circuit making it possible to rectify the alternating voltage recovered by the antenna circuit A3 and apply a rectified voltage to the terminals of the electrical load.

FIG. 3 is a schematic sectional view of a first embodiment of a receiver 3 according to the invention. The receiver 3 comprises a support 30, for example in the format of a credit card. The loop L1 is fixed on an upper face 31 of the support 30, and the loop L2 is fixed on a lower face 32 of the support 30. The loops L1 and L2 are connected electrically in parallel by way of an appropriate connection arrangement, and connected to the electronic circuit P3.

FIGS. 4 and 5 are views from above of the respective patterns of the loops L1 and L2. FIG. 6 illustrates a view from above of the superposition of the loops L1 and L2 on the support 30. The patterns of the loops L1 and L2 thus include superposed and interleaved crenellations. Such a configuration makes it possible to optimize the magnetic field sensing area of each loop for a support 30 of given dimensions.

In this example, the zero mutual inductance between the loops L1 and L2 is obtained by placing opposite one another portions traversed by currents of the same direction and portions traversed by currents of opposite directions, in a manner known per se to the person skilled in the art.

In order to limit the dimensions of the crenellations, and thus to limit the inductance of each of the loops L1 and L2 as well as the area that they occupy, the support 30 used is advantageously relatively slender, and exhibits for example a thickness of less than 1 mm, preferably less than 600 μm, more preferably less than 400 μm, or indeed less than 200 μm or even less than 100 μm. Low thicknesses favour increased coupling of the mutually opposite crenellation-like portions, and therefore make it possible to reduce the dimensions of the crenellations.

FIG. 7 is a schematic sectional view of a second embodiment of a receiver 3 according to the invention. The receiver 3 comprises a support 30, for example in the format of a credit card. The loop L1 is fixed on an upper face 31 of the support 30, and the loop L2 is fixed on a lower face 32 of the support 30. The loops L1 and L2 are connected electrically in parallel by way of an appropriate connection arrangement (including the respective pads PL11, PL12 and PL21, PL22), and connected to the electronic circuit P3.

FIGS. 8 and 9 are views from above of the respective patterns of the loops L1 and L2. FIGS. 8 and 9 also illustrate the directions of currents simultaneously traversing the loops L1 and L2. The loops L1 and L2 are connected so that their electromotive forces are in the same direction. For this purpose, the pad PL11 is connected to the pad PL22 to form one and the same power supply terminal for the chip P3. The pad PL12 is connected to the pad PL21 to form another power supply terminal for the electronic circuit P3. FIG. 10 illustrates a view from above of the superposition of the loops L1 and L2 on the support 30. As illustrated, the projections of the loops L1 and L2 in one and the same plane meet close to the periphery of the support 30, thereby optimizing the use of the faces of the support.

The loops L1 and L2 exhibit substantially the same geometric shape (square in this instance) and are shifted with respect to one another in the surfaces 31 and 32, as emerges more precisely from FIG. 10.

In this embodiment, each loop exhibits an appreciably smaller cross-section than that of the face on which it is disposed. However, the length of conductor of each loop is relatively small, thereby making it possible to obtain a relatively low inductance value. Consequently, a ratio S/L favouring optimal power recovery by the receiver is obtained. Indeed, each loop L1 or L2 exhibits a ratio S/L close to a single loop according to the prior art (S and L of a loop according to the invention being approximately half those of a loop according to the prior art). The ratio S/L of the loops L1 and L2 in parallel being the sum of the ratio S/L of each loop L1 and L2, this ratio is markedly greater than that of a single loop according to the prior art.

A theoretical calculation may be performed in the following example:

a single loop according to the prior art, of area 42 cm², could exhibit an inductance of 260 nH. The ratio S/L then rises to 162 cm²/pH;

a loop L1 or L2 of area 22.5 cm² would exhibit an inductance of 170 nH. The ratio S/L of this loop then rises to 132 cm²/pH. The loops L1 and L2 in parallel exhibit a ratio S/L of 264 cm²/pH.

Thus, the theoretical gain in ratio S/L in this example is 60% by using such loops L1 and L2.

Simulations and measurements having compared a single loop following the periphery of the support 30 with the second embodiment have made it possible to determine a gain of 40% in energy recovery with the above parameters.

The invention turns out to be particularly appropriate for receivers of small dimensions, exhibiting for example loops whose cross-section is less than 0.16 m², or indeed less than 54 cm². By cross-section of a loop is meant the area surrounded by this loop.

Although for the sake of simplification the invention has been described with embodiments comprising only two loops connected in parallel, the invention applies of course to receivers comprising a larger number of loops in parallel surfaces and exhibiting substantially zero mutual inductance. Such an example is schematically illustrated in FIG. 11, in which loops L1 to L4 connected in parallel are superposed. Such a modification would make it possible to obtain an increased overlap between the loops, while benefiting from a small inductance value. The loops L1 to L4 may be included inside a multilayer substrate.

FIG. 12 is a schematic electrical representation of an exemplary receiver structure according to the invention. In this example, the loops L1 and L2 are connected respectively to integrated circuits Ci1 and Ci2 (the loops L1 and L2 can of course also be connected to discrete components). The integrated circuits Ci1 and Ci2 comprise respectively capacitors C1 and C2 and rectifiers D1 and D2. The rectifier circuits D1 and D2 are connected to common terminals B1 and B2. The terminals B1 and 62 are intended for the connection of a load (the load including for example all the electronic functions of the receiver) having to be powered by the rectified signal.

Thus, the loops L1 and L2 can also be set in parallel after an electronics stage such as the rectifier circuit, the gain afforded by the invention remaining the same.

Although the receiver described comprises first loops in first parallel surfaces, provision may also be made for a receiver exhibiting increased sensitivity in relation to other axes, by including second loops in second surfaces which are not parallel to the first surfaces. The second loops will then exhibit similar properties to the first loops, namely electrical connection in parallel and substantially zero mutual inductance.

1.-15. (canceled)

16. An apparatus comprising a receiver furnished with a resonant antenna with inductive coupling, said receiver comprising an inductive antenna circuit comprising at least two conducting loops connected electrically in parallel, said loops being disposed on parallel surfaces and exhibiting substantially zero mutual inductance; and a circuit powered by the inductive antenna circuit, said circuit being modeled by a capacitor and a resistor that are connected parallel with the antenna circuit.

17. The apparatus of claim 16, wherein the two conducting loops have substantially equal values of inductance.

18. The apparatus of claim 16, wherein the two conducting loops are disposed on parallel surfaces of the same support on which they are fixed.

19. The apparatus of claim 18, wherein the support comprises a substrate on which an electronic circuit powered by the inductive antenna circuit is fixed.

20. The apparatus of claim 19, wherein the electronic circuit comprises an electrical load to be powered, and a rectifier circuit connected to terminals of the inductive antenna circuit and applying a rectified voltage to terminals of said electrical load.

21. The apparatus of claim 16, wherein said parallel surfaces are planar.

22. The apparatus of claim 16, wherein the resonant frequency of a circuit including the inductive antenna circuit, the capacitor, and the resistor is substantially equal to 13.56 megahertz.

23. The apparatus of claim 16, wherein the two conducting loops have the same direction of maximum sensitivity to a magnetic field.

24. The apparatus of claim 16, wherein a distance between said parallel surfaces is less than 1 millimeter.

25. The apparatus of claim 16, wherein said two conducting loops are first loops disposed on first parallel surfaces, and wherein the inductive antenna circuit comprises at least two second conducting loops connected electrically in parallel, exhibiting substantially zero mutual inductance and disposed in second parallel surfaces, the second parallel surfaces being non-parallel to the first surfaces.

26. The apparatus of claim 16, wherein the inductive antenna circuit has a quality factor of greater than 30.

27. The apparatus of claim 16, wherein the cross-section of each of said two loops is less than 0.16m²

28. The apparatus of claim 16, wherein said two loops are superposed and extend according to interleaved patterns.

29. The apparatus of claim 16, wherein said loops are formed of respective conducting circuits of similar shapes, said conducting circuits being shifted with respect to one another along said parallel surfaces.

30. The apparatus of claim 16, wherein said two conducting loops are connected in parallel by way of first and second terminals, whereby the two conducting loops induce one and the same electromotive force between the first and second terminals.
